(19) United States
(12) Patent Application Publication
(10) Pub. No.: US 2026/0192408 A1
(43) Pub. Date: Jul. 9, 2026

(54) METHOD FOR INDICATING A MISUSE OF A MACHINE TOOL

(71) Applicant: Hilti Aktiengesellschaft, Schaan (LI)

(72) Inventors: Rory BRITZ, Starnberg (DE); Daniel SELTMANN, Türkheim (DE); Markus HARTMANN, Mauerstetten (DE); Klaus HAUSER, Schwabmünchen (DE); Robert STANGER, Kaufbeuren (DE); Mathias FRENZEL, Unterdießen (DE); Moses ENDER, Kaufering (DE)

(21) Appl. No.: 19/133,572

(22) PCT Filed: Nov. 21, 2023
(86) PCT No.: PCT/EP2023/082573

§ 371 Date: May 28, 2025

(30) Foreign Application Priority Data
Dec. 6, 2022 (EP) 22211718.6

(51) Int. Cl. B23Q 11/00; B25F 5/00

(52) U.S. Cl. CPC B23Q 11/0085; B23Q 11/0092; B25F 5/00

(57) ABSTRACT

Method for controlling in an open and closed loop a power tool, in particular a handheld power tool, including a power tool housing, a control unit, a drive, a tool fitting, and an output device, with the method steps of detecting at least one acceleration value via the at least one acceleration sensor; sending at least one signal to the output device for the purpose of outputting at least one acoustic and/or visual warning signal if a detected acceleration value reaches a threshold value saved in the memory device, and/or sending at least one signal from the control unit for adjusting the drive from a first operating state into a second operating state.

The present invention relates to a method for controlling in an open and closed loop a power tool.

The present invention furthermore relates to a system including a power tool and a rechargeable battery which can be connected to the power tool for the purpose of performing the method according to the invention.

### BACKGROUND

Power tools with a rechargeable battery as an energy supply are widely known from the prior art. The power tool can be a hammer drill, a power drill, a saw, a grinder, or the like. The rechargeable batteries serving as an energy supply usually include a number of energy storage cells (also referred to as rechargeable battery cells), which serve and are designed to receive, store, and deliver electrical energy. The receiving of electrical energy into the energy storage cells can also be referred to as charging (or loading). The delivery of electrical energy from the energy storage cells can also be referred to as discharging.

### SUMMARY OF THE INVENTION

Significant malfunctions, damage, or even a permanent failure of the power tool or the rechargeable battery can be caused by the misuse of the power tool or the rechargeable battery as a hammer or as a substitute for a suitable hammer in order to exert blows (i.e. impacts or impulses) to objects (for example, a nail, screw, pin, or the like).

It is an object of the present invention is to solve the problem described above.

The present invention provides a method for controlling in an open and closed loop a power tool, in particular a handheld power tool, including a power tool housing, a control unit, a drive, a tool fitting, and an output device.

According to the invention, the following method steps are provided:
detecting at least one acceleration value via the at least one acceleration sensor;
sending at least one signal to the output device for the purpose of outputting at least one acoustic and/or visual warning signal if a detected acceleration value reaches a threshold value saved in the memory device, and/or
sending at least one signal from the control unit for adjusting the drive from a first operating state into a second operating state.

By sending and outputting at least one acoustic and/or visual warning sign, it is possible in a simple fashion for a user to be alerted to incorrect behavior which results in the acceleration values which correspond to or even exceed the threshold value. Repeating the incorrect behavior can be prevented as a result.

The first operating state can be an activation state of the power tool in which the drive generates a set speed. The second operating state can be a deactivation state of the power tool in which the drive does not generate any speed. It is thus possible, instead of or in addition to the outputting of at least one acoustic and/or visual warning signal, that the drive can be adjusted from a first operating state, i.e. a state in which speeds can be generated, into a second operating state, i.e. a state in which speeds can no longer be generated. The drive generates a first speed selected by a user for a predetermined period of time, for example 2 to 3 seconds. After this predetermined period of time has elapsed, the drive switches into the deactivation state, i.e. the drive no longer generates a speed if a detected acceleration value has reached the threshold value. As a result, a user can be alerted in a simple fashion to the fact that the acceleration values have reached a threshold value and handling which allows these acceleration values to be generated is not to be repeated.

The acceleration sensor is in particular a device for detecting shocks, vibrations, and impacts.

According to an advantageous exemplary embodiment, it can be possible that a first speed value is set in the first operating state for the drive, and a second speed value is set in the second operating state for the drive, wherein the second speed value is higher than the first speed value, and wherein the operating state alternates between the first and the second state for a predetermined period of time and/or frequency. As a result, a user of the power tool can be alerted to a clearly noticeable system change. The predetermined period of time can be 2 to 5 seconds and the predetermined frequency can be 1 to 5 Hz.

According to a further advantageous exemplary embodiment, it can be possible that a first speed value is set in the first operating state for the drive, and a second speed value is set in the second operating state for the drive, wherein the second speed value is at least 50% higher than the first speed value. By virtue of the relatively high difference in speed which is perceptible for a user, a user of the power tool can be alerted to a clearly noticeable system change and their attention drawn to wrong behavior.

The object is furthermore achieved by a system including a power tool and a rechargeable battery which can be connected to the power tool for the purpose of performing the method according to the invention, wherein the power tool includes a housing, a control unit, a drive, a tool fitting, and an output device, and the rechargeable battery includes a battery housing, at least one energy storage element, and a control device.

According to the invention, it is provided that at least one acceleration sensor for detecting at least one acceleration value is included in the power tool and/or in the rechargeable battery.

According to a further exemplary embodiment, it can be possible that at least one acceleration sensor for detecting at least one acceleration value is included both in the power tool and in the rechargeable battery. The at least one acceleration sensor in the power tool and the at least one acceleration sensor in the rechargeable battery are connected to each other by means of a line such that detected acceleration values can be exchanged between the power tool and the rechargeable battery and compared with each other.

The at least one acceleration sensor in the power tool and the at least one acceleration sensor in the rechargeable battery can furthermore also be connected to each other by means of a wireless connection (for example, Bluetooth, NFC (=near field communication), or the like).

### BRIEF DESCRIPTION OF THE DRAWINGS

Further advantages can be found in the following description of the figures. A particularly preferred exemplary embodiment of the present invention is illustrated in the figures. The figures, the description, and the claims include numerous features in combination. A person skilled in the art will expediently also consider the features individually and combine them to form sensible further combinations.

In the figures, identical and similar units, components, and parts are denoted by the same reference signs.

In the drawings:

FIG. 1 shows a side view of a system having a power tool and a rechargeable battery which is connected to the power tool;

FIG. 2 shows a side view in section of the rechargeable battery; and

FIG. 3 shows a further side view of the system having the power tool and the rechargeable battery during the use of the system to exert impact impulses on a nail.

### DETAILED DESCRIPTION

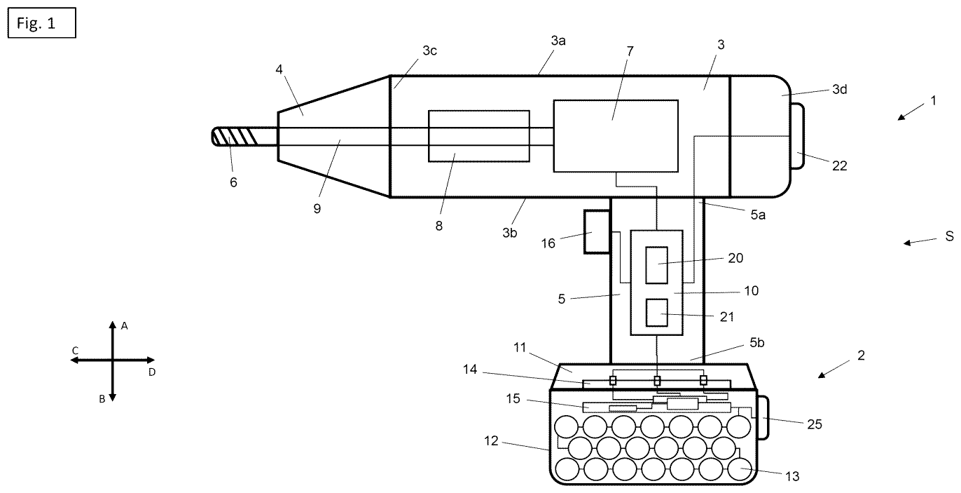

FIG. 1 shows a system S formed of a power tool 1 and a rechargeable battery 2 according to an exemplary embodiment. The rechargeable battery 2 is removably connected to the power tool 1 in order to supply the power tool 1 with electrical energy.

The power tool 1 is configured as a power drill in the embodiment shown. Alternatively, the power tool 1 can also be configured as a screwdriver, a hammer drill, a saw, a grinder, or the like.

As indicated in FIG. 1, the power tool 1 configured as a power drill essentially includes a power tool housing 3 with a tool fitting 4 and a handle 5.

The tool fitting 4 serves to receive and retain a tool 6. The tool 6 is a drill bit in the present exemplary embodiment. Alternatively, the tool 6 can also be configured as a screwdriver bit.

A drive 7, a transmission 8, an output shaft 9, and a control unit 10 are, inter alia, provided in the interior of the power tool housing 3. The drive 7 is configured, for example, as a brushless electric motor and serves to generate torque.

The control unit 10 controls in a closed and open loop the functions and the behavior of the power tool 1 and in particular the drive 7, i.e. the direction of rotation and speed of the drive 7. An acceleration sensor 21 and a memory device 20 are furthermore included in the control unit 10.

The acceleration sensor 21 serves to detect accelerations in the form of acceleration values which act on the system and in particular on the power tool 1. It can be established with the aid of the detection of acceleration values whether and with what intensity shocks, vibrations, and/or impacts act on the system S and the power tool 1. The acceleration sensor 21 is connected to the control unit 10 such that detected acceleration values can be sent to the control unit 10.

Threshold values for accelerations of the system S and for the power tool 1 are, inter alia, saved in the memory device 20.

The handle 5 in turn includes an actuating switch 16, an upper end 5a, and a lower end 5b. The actuating switch 16 is connected to the control unit 10 such that actuating the actuating switch 16 in direction D results in an activation of the drive 7 or the power tool 1.

As also shown in FIG. 1, the drive 7, the transmission 8, the output shaft 9, and the tool fitting 4 are arranged relative to one another such that torque generated by the drive 7 can be transmitted to the tool fitting 4 via the transmission 8 and the output shaft 9. The torque generated by the drive 7 is ultimately transmitted to the tool 6 by the tool fitting 4.

The power tool housing 3 furthermore has an upper side 3a, a lower side 3b, a front end 3c, and a rear end 3d.

The tool fitting 4 is positioned at the front end 3c of the power tool housing 3. The upper end 4a of the handle 5 is fastened to the lower side 3b and in the vicinity of the rear end 3d of the power tool housing 3. A power tool interface 11 is positioned at the lower end 5b of the handle 5. The power tool interface 11 serves to releasably connect the power tool 1 to the rechargeable battery 2.

According to an alternative exemplary embodiment, the power tool 1 can also be configured such that it is connected to more than one rechargeable battery 2 as an energy source.

A first output device 22, which is connected to the control unit 10 via a corresponding line L in order to receive signals from the control unit 10 is positioned at the rear end 3d of the power tool housing 3. The first output device 22 includes a loudspeaker and a lamp. Neither the loudspeaker nor the lamp are shown in the figures.

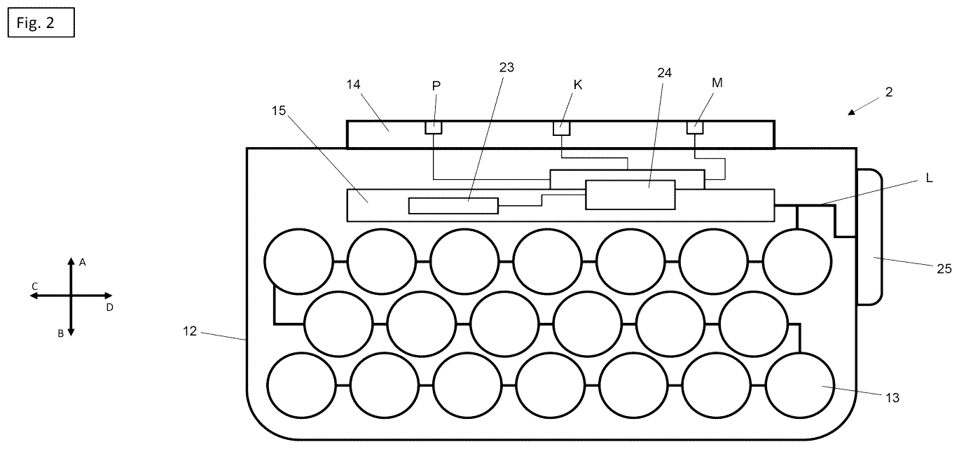

The rechargeable battery 2 described in the exemplary embodiment can be used in particular as an energy storage apparatus or electrical energy source for the power tool 1. The rechargeable battery 2 here essentially includes a rechargeable battery housing 12, a number of energy storage cells 13, a rechargeable battery interface 14, an acceleration sensor 23, a memory device 24, a second output device 25, and a control device 15 (see, e.g., FIG. 2).

The acceleration sensor 23 is used to detect acceleration values. It can be established with the aid of the detection of acceleration values whether and with what intensity shocks, vibrations, and/or impacts act on the system S and the rechargeable battery 2. The acceleration sensor 23 of the rechargeable battery 2 is connected to the control device 15 such that detected acceleration values can be sent to the control device 15.

Threshold values for accelerations of the system S and for the rechargeable battery 2 are, inter alia, saved in the memory device 24 of the rechargeable battery 2.

The second output device 25 is connected to the control device 15 via a corresponding line L in order to receive signals from the control unit 10. The second output device 25 also includes a loudspeaker and a lamp. Neither the loudspeaker nor the lamp of the second output device 25 are shown in the figures.

The rechargeable battery interface 14 serves to electrically or electronically connect the rechargeable battery 2 to the power tool 2 by means of the power tool interface 11. For this purpose, the rechargeable battery interface 14 includes a positive contact P, a negative contact M, and a communication contact K. The positive contact P and negative contact M serve to transmit electrical energy from the energy storage cells 13 of the rechargeable battery 2 to the consumers (in particular the drive 7) of the power tool 1. The communication contact K in turn serves for the communication between the control device 15 of the rechargeable battery 2 and the control unit 10 of the power tool 1. For the communication between the rechargeable battery 2 and the power tool 1, data and information are exchanged in the form of signals.

The energy storage cells 13 can also be referred to as rechargeable battery cells and serve to receive, store, and deliver again electrical energy. As indicated in the figures, the energy storage cells 13 are cylindrical and configured on the basis of lithium-ion technology. Each energy storage cell 13 includes, at one end, a contact device which serves for the transmission, i. e the receipt and delivery, of electrical energy. The individual contact devices are connected to the control device 15 via corresponding lines L.

The contact devices are not illustrated in the figures.

Alternatively, the energy storage cells 13 can also be based on another suitable technology. The cylindrical shape of the energy storage cells 13 is likewise optional such that any other suitable shape or geometry can also be selected. It is thus in particular also possible that the energy storage cells 13 are configured as pouch cells. It is additionally also possible that the rechargeable battery 2 includes both cylindrical energy storage cells and pouch cells.

The control device 15 controls the different functions of the rechargeable battery 2 in a closed-loop and open-loop manner. These functions include, inter alia, the closed-loop control of the receipt and delivery of electrical energy.

In addition, the control device 15 is connected to the energy storage cells 13 and the rechargeable battery interface 14 via corresponding lines L such that electrical energy can pass from the energy storage cells 13 via the control device 15 to the rechargeable battery interface 14.

To removably mechanically couple the rechargeable battery 2 to the power tool 1, the system S consisting of a power tool 1 and a rechargeable battery 2 includes a rail apparatus. The rail apparatus is positioned between the rechargeable battery interface 14 and the power tool interface 11 such that the rechargeable battery 2 can be slid along the rail apparatus and onto the power tool 1 in the direction of arrow C and removed (slid off) from the power tool 1 again in the direction of arrow D. When the rechargeable battery 2 is coupled to the power tool 1 with the aid of the rail apparatus, the positive contact P, the negative contact M, and the communication contact K of the rechargeable battery 2 are in contact with the corresponding positive and negative contacts P, M and the communication contact K of the power tool 1. Electrical energy and electrical signals can then be transmitted from the rechargeable battery 2 to the power tool 1.

The rail apparatus is not shown in the figures.

A locking apparatus (not shown in the figures) is used to removably connect the rechargeable battery 2 to the power tool 1.

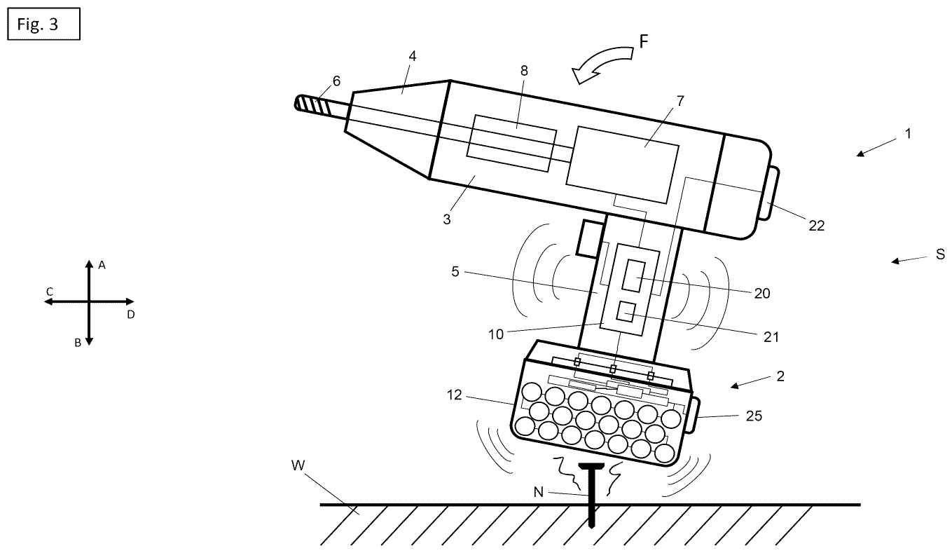

In order to perform the method, an acceleration value is determined first by the acceleration sensor 21 of the power tool 1 when the system S is used to drive a nail N into a material W, cf FIG. 3. In order to drive the nail N into the material W, a force F is repeatedly exerted on the nail N by the user via the system S.

The shocks to the system S, which are generated when the nail N is being driven in by the system S, are detected with the aid of the acceleration sensor 21 in the form of acceleration values.

The acceleration values detected by the acceleration sensor 21 are sent to the control unit 10 of the power tool 1 in the form of signals. The detected acceleration values are compared by the control unit 10 with the acceleration threshold values stored in the memory device 20. If detected acceleration values reach or exceed the acceleration threshold values, a signal is sent to the output device 22 by the control unit 10. The output device 22 thereupon sends an acoustic warning signal in the form of a signal tone and a visual warning signal in the form of a signal lamp.

In addition or as an alternative to sending a signal from the output device 22, a signal is sent by the control unit 10 in order to adjust the drive from a first operating state into a second operating state.

A first speed value is set for the drive 7 in the first operating state, and a second speed value is set for the drive 7 in the second operating state. The second speed value is in this case higher than the first speed value. In the present exemplary embodiment, adjusting the drive 7 from a first speed value into a second speed value means that, when the acceleration values which reach or exceed the predetermined threshold values are detected, either the drive 7 is operated already at a first speed value and then operated at a second speed value, or that a first speed value selected by a user is set or changed automatically by the control unit 10 to a second speed value only when the drive 7 is activated again (i.e. speed value=zero).

According to a further embodiment, a switch is made between the first and second operating state for a predetermined period of time and/or frequency. In other words, the drive 7 is operated alternately at a certain frequency and for certain periods of time in the first or second operating state.

Instead of or in addition to the detection of acceleration values with the aid of the acceleration sensor 21 of the power tool 1, acceleration values can also be detected by the acceleration sensor 23 of the rechargeable battery 2.

The abovedescribed method can thus be performed also with the aid of the acceleration sensor 23 of the rechargeable battery 2.

### LIST OF REFERENCE SIGNS

1 power tool
2 rechargeable battery
3 power tool housing
3a upper side of the power tool housing
3b lower side of the power tool housing
3c front end of the power tool housing
3d rear end of the power tool housing
4 tool fitting
5 handle
5a upper end of the handle
5b lower end of the handle
6 tool
7 drive
8 transmission
9 output shaft
10 control unit of the power tool
11 power tool interface
12 rechargeable battery housing
13 energy storage cells
14 rechargeable battery interface
15 control device
16 actuating switch
20 memory device of the power tool
21 acceleration sensor of the power tool
22 first output device on the power tool
23 acceleration sensor of the rechargeable battery
24 memory device of the rechargeable battery
25 second output device on the rechargeable battery
L line
P positive contact
M negative contact
K communication contact
S system
N nail
W material
F force

What is claimed is:

1-5. (canceled)

6: A method for controlling in an open and closed loop a power tool including a power tool housing, a control unit, a drive, a tool fitting, and an output device, the method comprising steps of
detecting at least one acceleration value via at least one acceleration sensor;
sending at least one signal to the output device for the purpose of outputting at least one acoustic and/or visual warning signal if a detected acceleration value reaches a threshold value saved in the memory device, or sending at least one signal from the control unit for adjusting the drive from a first operating state into a second operating state.

7: The method as recited in claim 6 wherein the signal is sent from the control unit for adjusting the drive from the first operating state into the second operating state and a first speed value is set in the first operating state for the drive, and a second speed value is set in the second operating state for the drive, wherein the second speed value is higher than the first speed value, and wherein the operating state alternates between the first and the second state for a predetermined period of time or frequency.

8: The method as recited in claim 6 wherein the signal is sent from the control unit for adjusting the drive from the first operating state into the second operating state and wherein a first speed value is set in the first operating state for the drive, and a second speed value is set in the second operating state for the drive, wherein the second speed value is at least 50% higher than the first speed value.

9: The method as recited in claim 6 wherein the power tool a handheld power tool.

10: A system for performing the method as recited in claim 6, the system comprising:
the power tool; and
a rechargeable battery connectable to the power tool, the rechargeable battery including a rechargeable battery housing, at least one energy storage element, and a control device; and
the at least one acceleration sensor for detecting at least one acceleration value being included in the power tool or in the rechargeable battery.

11: The system as recited in claim 10 wherein the rechargeable battery includes at least one battery output device connected to the control device and to the acceleration sensor.
